(19) United States
(12) Patent Application Publication
(10) Pub. No.: US 2013/0202759 A1
(43) Pub. Date: Aug. 8, 2013

(54) METHOD FOR IMPROVING YIELD IN MALTING PROCESS

(71) Applicants: Sebastien Frere, Meerbeek (BE); Philip J. Phillips, Monticello, MN (US); Xiang S. Yin, Medina, MN (US)

(72) Inventors: Sebastien Frere, Meerbeek (BE); Philip J. Phillips, Monticello, MN (US); Xiang S. Yin, Medina, MN (US)

(73) Assignee: CARGILL, INCORPORATED, Wayzata, MN (US)

(21) Appl. No.: 13/639,957

(22) PCT Filed: Apr. 8, 2011
(86) PCT No.: PCT/US11/31723

§ 371 Date: Jan. 3, 2013

Related U.S. Application Data
(60) Provisional application No. 61/322,439, filed on Apr. 9, 2010.

(30) Foreign Application Priority Data
Apr. 21, 2010 (EP) 10004207.6

(51) Int. Cl. A23L 1/10

(52) U.S. Cl. CPC A23L 1/1025
USPC 426/507

(57) ABSTRACT

Processes for improving yield in the malting process are described. Utilization of conditioned water in the germination stage of the malting process can result in an improved malt yield. The conditioned water comprises from 0.025% to 2% chloride salt.

### CROSS REFERENCE TO RELATED APPLICATIONS

This application claims the benefit of the filing date of U.S. Provisional Application No. 61/322,439, which was filed on Apr. 9, 2010, and European Patent Application No. EP10004207.6, which was filed on Apr. 21, 2010. The contents of U.S. Provisional Application No. 61/322,439 and European Patent Application No. EP10004207.6 are incorporated by reference in their entirety as part of this application.

### FIELD OF THE INVENTION

The present invention relates generally to improving yield in the malting process.

### BACKGROUND OF THE INVENTION

Malted grains are used to make many foods and beverages for humans and animals. Most importantly, malted barley is used in the brewing industry to make beer. Millions of tons of barley and other cereal grains are malted every year for use in beer, foods, and beverages.

### SUMMARY OF THE INVENTION

The present invention features a process for improving yield in the malting process. The process includes applying conditioned water to germinating cereal grain in the germination stage of the malting process. The conditioned water includes from 0.025% to 2% chloride salt. In some embodiments, the conditioned water can be sprayed onto the germinating cereal grain. In some embodiments, the cereal grain is barley.

In some embodiments, the chloride salt can be sodium chloride, potassium chloride, calcium chloride, or mixtures of two or more of these chloride salts. In other embodiments, the chloride salt is sodium chloride.

In some embodiments, the conditioned water includes from 0.1% to 1% chloride salt. In other embodiments, the conditioned water includes 0.1% to 0.5% chloride salt. In yet other embodiments, the conditioned water includes 0.025% to 0.12% chloride salt. In yet other embodiments, the conditioned water includes 0.04% to 0.08% chloride salt. In yet other embodiments, the conditioned water includes 0.05% to 0.2% chloride salt. In yet other embodiments, the conditioned water includes 0.08% to 0.12% chloride salt.

In some embodiments, the conditioned water can be applied to the cereal grain within 48 hours from the start of germination, or within 32 hours from the start of germination. In other embodiments, the conditioned water can be sprayed onto the barley between 15 hours and 40 hours from the start of germination. In yet other embodiments, the conditioned water can be sprayed onto the barley between 30 hours and 48 hours from the start of germination.

Another aspect of the invention features the use of conditioned water in the germination stage of the malting process to improve malt yield. The conditioned water includes from 0.025% to 2% chloride salt, and the conditioned water is applied to cereal grains during the germination stage of the malting process. In some embodiments, the conditioned water can be sprayed onto the germinating cereal grain. In some embodiments, the cereal grain is barley. In some embodiments, the chloride salt is sodium chloride.

In some embodiments, the conditioned water is sprayed onto the barley within 48 hours from the start of germination. In other embodiments, the conditioned water is sprayed onto the barley within 32 hours from the start of germination. In yet other embodiments, the conditioned water is sprayed onto the barley between 15 hours and 40 hours from the start of germination.

### DETAILED DESCRIPTION OF THE INVENTION

### Definitions

The term “chloride salt”, as used herein, means an inorganic salt in which the anion component of the salt is made up of one or more chloride ions (Cl⁻). The chloride salts of the present invention are generally easy to obtain, relatively inexpensive, and simple to utilize and incorporate in a malting process. The chloride salt of the present invention also comports with known safe food use guidelines typically adhered to in the commercial malting industry.

Preferred chloride salts which could be used in the present invention include sodium chloride (NaCl), potassium chloride (KCl), and calcium chloride (CaCl₂). More preferably, the chloride salt used in the present invention is sodium chloride or potassium chloride. Most preferable, the chloride salt useful for the present invention is sodium chloride.

The term “conditioned water”, as used herein, means water to which a chloride salt has been added, or which includes the herein disclosed concentrations of chloride salt.

### General Malting Process

The malting process is well known in the art. Many cereal grains can be malted including, but not limited to, barley, wheat, buckwheat, rye, maize, rice, and oats. Cereal grains can be malted to modify their kernel structure, composition and enzyme content. The resulting malts have many important uses in food for animals and humans. The most important malted material is malted barley, which is used in the brewing and distilling industries. The malting process and the present invention will be described below for barley, but it is understood that the present invention can be utilized in the malting of other types of cereal grains.

The process of malting barley consists primarily of three stages: steeping, germination, and kilning. The three main stages of malting will be described in greater detail in individual sections below. Prior to steeping, barley kernels can go through some processing to select and prepare them for the malting process. Specifically, barley kernels can be cleaned and stored for a period of time prior to steeping. Additionally, because different size barley kernels absorb moisture at different rates, it can be desirable to process uniform kernel sizes to improve product uniformity and quality.

Factors such as the protein content of the barley, water quality, and configuration of infrastructure can also contribute to variability of moisture uptake. In addition, it is understood that a large number of factors ranging from agronomy to barley variety to process infrastructure can contribute to variability in rate of moisture uptake of barley kernels, and are considered during grain selection and sorting. Once the appropriate kernels are selected and prepared, these kernels are then steeped.

Steeping refers to the immersion of barley kernels in water to increase the moisture content of the kernels. After steeping, the barley kernels are typically transferred to germination compartments to undergo the germination process. Germination refers to a period of controlled growth and modification of the kernels. Modification of barley kernels is well known in the art to encompass cell wall degradation in the starchy endosperm, creation of soluble proteins and free amino nitrogen, and synthesis of desirable enzymes. After the barley kernels have been modified to the desired degree, the grains are subjected to the kilning stage. Kilning refers to the controlled drying of the germinated barley.

After kilning is complete, the kernels are screened during which time the bulk of rootlets and in some cases acrospires are separated from the kernels. The separated rootlets, acrospires, as well as grain respiration which occurs during malting, represent a loss in the malting process, the so called “malting loss”. The amount of malted barley remaining after completion of the malting process and removal of rootlets, acrospires, and other undesirable materials is referred to as the malt yield. The present invention provides a simple to use process improvement which, when incorporated into a conventional malting process, provides a yield improvement over such a conventional malting process. The present invention can also be easily incorporated into conventional malting processes without significant need for new equipment or complex process steps. The conventional malting process is well known in the art and, for example, is described in D. E. Briggs, Malts and Malting, Springer (1998); D. E. Briggs, J. S. Hough, R. Stevens, and T. W. Young, Malting and Brewing Science, Volume 1, Malt and Sweet Wort, Springer Verlag (1981); A. W. MacGregor and R. S. Bhatty, eds., Barley: Chemistry and Technology, American Association of Cereal Chemists (1996).

### Steeping

The first main stage of the malting process is the steeping of the barley kernels. The barley kernels are immersed in water which may or may not be aerated. Typically, steeping can include a series of water immersions. These water immersions can be separated by periods of air rest under ventilation.

During steeping, respiration of the barley begins and heat and gases are given off although no significant growth takes place. The goal of steeping is to increase the moisture level of the barley kernels from approximately 10% as harvested to 40-45% moisture. Properly hydrating the barley to target moisture levels can be accomplished by manipulation of immersion times, air rest time, and immersion water temperature among other infrastructure and process recipe means. When steeping is completed, the embryo is swollen with moisture and is generally visible. Tips of the barley rootlets are generally just appearing. This visible swelling of the embryo and emergence of the rootlets is referred to as “chitting”.

The conventional steeping of barley is well known in the art. Aspects of steeping are described, for example, in D. E. Briggs, Malts and Malting, Springer (1998); D. E. Briggs, J. S. Hough, R. Stevens, and T. W. Young, Malting and Brewing Science, Volume 1, Malt and Sweet Wort, Springer Verlag (1981); A. W. MacGregor and R. S. Bhatty, eds., Barley: Chemistry and Technology, American Association of Cereal Chemists (1996).

### Germination

The second main stage of the malting process is germination. Germination broadly involves subjecting the steeped barley kernels to appropriate conditions of temperature, moisture, and airflow for a time sufficient for the starchy interior portion of the barley kernel (the endosperm mass) to be made more friable and modified by cell wall degradation, and growth of the embryo facilitated. Growth typically begins slowly on the first day of germination, and accelerates during the second day. Most germinations are 4 day processes, though 3 day processes are also known as well as germination processes which can last 5 or more days.

During germination, the barley kernel completes chitting and rootlets grow outwardly from the embryo of the kernel. The acrospire (also known as “first leaf”) also starts to grow from the embryo at the base of the kernel and grows under the hull toward the top end of the kernel. Growth of the acrospire in germination is a key parameter monitored by the commercial maltster. Typically, it is desired for well-modified malt to have the acrospire reaching ¾ to 100% of the kernel length by the end of germination. Malt products desiring a lower degree of modification may be ½ to ¾ or less than 100% the length of the kernel. Malt products requiring an extremely high degree of modification may be well in excess of 100% of the kernel, and may even have acrospires past the end of the kernel by 100% or more the length of the kernel.

Germination compartments generally use a slotted screen false floor allowing the compartment to receive a continuous humidified and temperature controlled airflow and allowing excess moisture to drain through the bed. Germination compartments are equipped with turning machines, or some means for turning the germinating barley kernels, approximately every 8 hours to minimize temperature differences between the top and bottom of the germination bed and to prevent rootlets from growing together and matting. Large air handling fans are used to transfer fresh air, recirculation air, and/or any blend of fresh and recirculation air through water spray humidification and temperature controlled chambers, and force the air through the germinating grain. The barley kernels, during growth, give off considerable heat and carbon dioxide. It is important to near continuously pass temperature controlled humidified air through the germination compartment to remove the carbon dioxide and heat produced by grain respiration, as well as to slow the rate of moisture loss, provide a means of controlling the germination compartment temperature, and control overall rate of barley growth.

Turning machines, used to turn germinating barley kernels and prevent rootlets from growing together, are typically equipped with a spray bar capable of delivering water to the growing barley. Other means of applying water to the barley are also possible. Generally, the germinating barley loses approximately 1% moisture per day during germination. The spray bars can be used to add back this lost moisture, and increase moisture level if desired, to the germinating barley through a metered watering.

Generally, sufficient water is applied to the germination compartment to wet the germinating barley, while allowing a minimal amount to leak out the bottom of the germination compartment. The germinating barley is ready to water when it is dry of surface moisture from steeping or a previous watering. Typically, after 24 hours from the start of the germination stage, the germinating barley is ready for its first watering. Depending on the initial moisture level of the barley kernels out of the steeping stage, the process goals for degree of modification, or customer specification, watering may occur every 8-12 hours after the initial watering. A second, third, fourth, or more waterings may be used. During germination, the moisture level of the barley increases from approximately 40%-45% at the beginning of germination to approximately 45%-50%. It is understood that different conditions and parameters can be used in the gennination stage of the malting process depending on the barley conditions, the variety of barley starting material, the desired attributes of the malt output, and the size, type, or other physical attributes and limitations of the particular germination compartment used.

Barley respiration, rootlet growth, and acrospires are considered typical examples of malting loss. In the case of respiration loss, the barley releases carbon dioxide as a byproduct of metabolic activity which consumes grain mass. In the case of rootlet growth, rootlets are formed consuming grain mass and subsequently cleaned off following kilning. Acrospires in excess of the kernel length or that grow outside of the husks are also cleaned off following kilning, resulting in a loss of saleable malt mass. Though acrospires in excess of kernel length and rootlets retain minimal value in residual feed streams, they are a significant loss to the malting process.

The germination stage of the malting process is well known in the art. Certain aspects of germination are described, for example, in D. E. Briggs, Malts and Malting, Springer (1998); D. E. Briggs, J. S. Hough, R. Stevens, and T. W. Young, Malting and Brewing Science, Volume 1, Malt and Sweet Wort, Springer Verlag (1981); A. W. MacGregor and R. S. Bhatty, eds., Barley: Chemistry and Technology, American Association of Cereal Chemists (1996).

The present invention features a process for improving malt yield. This process includes applying conditioned water to germinating cereal grains, preferably barley, in the germination stage of the malting process. The conditioned water includes from 0.025% to 2% chloride salt. The optimal concentration of chloride salt in the conditioned water and particular time of application of the conditioned water during the germination stage of the malting process may vary based on certain factors such as the variety of barley being malted, the size, type, or other physical attributes and limitations of the particular germination compartment used, ambient environmental conditions, seasonal weather variations, and the key malting attributes desired for commercial consideration such as degree of modification, degree of enzyme development, among other attributes.

Two principal types of cultivated barley are used in the malting process, 2-row and 6-row. Cultivated barley can further be broken into fall planted winter barley, and spring planted spring barley. Each of these types of barley has several varieties which are used in the malting industry. A malt barley variety refers to a variety of barley typically cultivated and developed from a barley breeding program. Barley variety development will typically utilize germ plasm collections to develop varietal traits most beneficial to desired malt quality, and desired agronomical characteristics. Malting quality barley varieties are in development in the private sector, through governments, universities, and amongst national and international organizations.

Different barley varieties have different characteristics. Moreover, these varieties are constantly being modified, in some cases due to nature, but primarily due to the desire to produce new varieties of barley having particularly desired characteristics such as better agronomic capability, better germination capability, and low protein content, among others.

Since the characteristics in each variety can vary, the malting parameters may also need to be varied depending on the properties of the resulting malt desired. Similarly, certain parameters of the present invention (particularly the concentration of chloride salt in the conditioned water, and time of conditioned water addition) may also vary to obtain optimal improvement of malt yield.

Examples of barley varieties include Sebastian, Moravian, Copeland, Tipple, Metcalfe, Tradition, Scarlett, Barke and Stellar. This list is not exclusive as there are hundreds of barley varieties and more are constantly being created.

Different types of germination compartments can be used in the germination stage of the malting process. These compartments can vary in size, depth, method of water application, method of humidification, and temperature control among other differences. These differing physical characteristics may affect the optimal concentration of chloride salt in the conditioned water and particular time of application of the conditioned water in the germination stage of the malting process.

Certain germination compartments, varieties of barley, and/or other factors may call for a slightly higher concentration of chloride salt in the conditioned water. In some of these embodiments, the concentration of chloride salt can range from 0.1% to 2%. In other embodiments, the concentration of chloride salt can range from 0.1% to 1.5%. In yet other embodiments, the concentration of chloride salt can range from 0.1% to 1%. In yet other embodiments, the concentration of chloride salt can range from 0.1% to 0.5%. In yet other embodiments, the concentration of chloride salt can range from 0.15% to 0.3%. In yet other embodiments, the concentration of chloride salt is about 0.2%.

Certain geimination compartments, varieties of barley, and/or other factors may call for a slightly lower concentration of chloride salt in the conditioned water. In some of these embodiments, the concentration of chloride salt can range from 0.025% to 0.12%. In other embodiments, the concentration of chloride salt can range from 0.03% to 0.1%. In yet other embodiments, the concentration of chloride salt can range from 0.04% to 0.08%. In yet other embodiments, the concentration of chloride salt is about 0.06%.

Certain germinating conditions, varieties of barley, and/or other factors may for a relatively intermediate concentration of chloride salt in the conditioned water. In some of these embodiments, the concentration of chloride salt can range from 0.05% to 0.2%. In other embodiments, the concentration of chloride salt can range from 0.07% to 0.15%. In yet other embodiments, the concentration of chloride salt can range from 0.08% to 0.12%. In yet other embodiments, the concentration of chloride salt is about 0.1%.

The conditioned water can be applied to the gellninating grains in any manner known in the art. In some embodiments, the conditioned water can be sprayed onto the germinating grains. In these embodiments, a spray bar connected to a turning device may be used to spray the germinating grains with conditioned water.

The conditioned water can be applied to the germinating grains at any time during the germination stage of the malting process useful for improving malt yield. Certain embodiments may call for an earlier application of conditioned water to the germinating grains while other embodiments may call for a later application. These differences may be due to physical characteristics of the germination compartment used as well as the variety of barley being malted.

In some embodiments, the conditioned water can be applied within 72 hours from the start of germination. In other embodiments, the conditioned water can be applied within 48 hours from the start of germination In yet other embodiments, the conditioned water can be applied within 40 hours from the start of germination. In yet other embodiments, the conditioned water can be applied within 32 hours from the start of germination. In yet other embodiments, the conditioned water can be applied within 28 hours from the start of germination. In yet other embodiments, the conditioned water can be applied between 15 hours and 40 hours from the start of germination. In yet other embodiments, the conditioned water can be applied between 20 hours and 30 hours from the start of germination. In yet other embodiments, the conditioned water can be applied between 30 hours and 48 hours from the start of germination. In yet other embodiments, the conditioned water can be applied between 35 hours and 48 hours from the start of germination.

In some particular embodiments, water conditioned with sodium chloride at a concentration of 0.075%-0.15% is sprayed onto the germinating grains between 15 hours and 40 hours from the start of germination. In other particular embodiments, water conditioned with sodium chloride at a concentration of 0.08%-0.12% is sprayed onto the germinating grains between 20 hours and 30 hours from the start of germination.

Another aspect of the present invention features the use of a chloride salt in the germination stage of the malting process. The chloride salts are those described above, and can be used at the concentrations and in the manner described above in the germination stage.

### Kilning

The third main stage of the malting process is kilning. In the kilning process the germinated barley (green malt) is heated in a kiln to reduce its moisture content and stop further growth. Kilning is typically comprised of 3 phases: wither, pre-cure/post wither, and cure. Green malt is typically transferred to a kiln immediately following germination. Most commercial kilns are slotted floor false bottom allowing air to pass through the green malt. Kilns usually have a means to minimally level the green malt bed for efficient drying, and may utilize turning machines as in germination to mix, turn, or level the green malt bed. Kilning is essentially a process of performing a regulated removal of water from the green malt.

The first main phase of kilning is the wither phase. In this phase the green malt at approximately 45% moisture at the end of germination is subjected to moderate temperature and high volume airflow. Generally, the temperature applied to the bed in the wither phase is maintained at approximately 60° C. and the moisture content of the grain is reduced from initial kiln loading levels to approximately 20%-25%. During the wither phase, germination continues during the initial period when the grain still contains high levels of moisture, but growth and modification slows and stops once the rootlets are “withered”, with removal of all surface moisture as well as the more easily removed moisture in the embryo area of the grain.

In the second phase of kilning, the pre-cure/post wither phase, moisture level in the grain is reduced from approximately 20%-25% to approximately 12%-15%, and the grain appears dry to the touch. Applied temperature is increased and airflow is typically decreased in this phase.

In the third phase of kilning, the cure phase, the temperature is increased to the maximum set point for the process, kiln, or the desired malt outcome. The cure phase typically defines the product color and flavor development of the malt, as well as driving off undesirable volatiles, and reducing final product moisture content to a microbiologically, food safe level of approximately 4%. Curing generally involves heating the malt to approximately 85° C. for a period of 2 to 4 hours. Temperatures used and time applied, however, vary widely among commercial maltsters, and among product lines being produced. The kilning stage is well known in the art. Certain aspects of kilning are described, for example, in D. E. Briggs, Malts and Malting, Springer (1998); D. E. Briggs, J. S. Hough, R. Stevens, and T. W. Young, Malting and Brewing Science, Volume 1, Malt and Sweet Wort, Springer Verlag (1981); A. W. MacGregor and R. S. Bhatty, eds., Barley: Chemistry and Technology, American Association of Cereal Chemists (1996).

### Effect of the Inventive Process

The present invention provides a process for improving malt yield while providing malted barley useful for brewing. Utilizing conditioned water—water containing particular concentrations of chloride salt—in the germination stage of the malting process can provide an increased malt yield compared to a comparable conventional malting process which does not incorporate the present invention. Additionally, the fact that the chloride salts preferred for use in the present invention are generally food-safe, and can be used at low levels, results in a malt product substantially free of undesirable additives.

The benefits provided by the present invention are exemplified in the examples below. These examples show that utilization of the present invention can result in an improvement in malt yield of up to 1% or even higher while providing malted barley useful for brewing, distilling, or other food and beverage applications. Such an improved malt yield can bring about considerable financial benefits to a commercial maltster. In addition, incorporation of the present invention to a conventional malting process does not require significant capital expenditure. The present invention provides a cost effective and easy to use malting process improvement which surprisingly improves malt yield while maintaining desired malt quality attributes.

### EXAMPLES

The present invention is further illustrated by the examples provided below. It is understood that these examples are not intended to limit the scope of the present invention in any way.

### Example 1

A Joe White micro-malting system was used test 6 samples of barley. This micro-malting system allows for steeping, germination, and kilning of samples in one unit while providing uniformity of malting conditions for each batch. Each sample was placed in one compartment of the micro-malting system. Samples were analyzed with and without water conditioned with sodium chloride utilized in the steeping and/or germination stages. One kilogram of barley was added to each of 6 compartments in the micro-malting unit. Table 1 describes experimental conditions utilized in this example.

TABLE 1

| Compartment/Sample | Experimental Conditions |
|---|---|
| 1 (Control) | No NaCl used |
| 2 | 1% NaCl solution applied to germination at day 2 |
| 3 | 2% NaCl solution used as steep water |
| 4 | 2% NaCl solution used as steep water + 1% NaCl |
| | solution applied to germination at day 2 |
| 5 | 4% NaCl solution used as steep water |
| 6 | 4% NaCl solution used as steep water + 1% NaCl |
| | solution applied to germination at day 2 |

Two immersions steeping cycle was used for all barley samples. The barley was steeped with the first water immersion for 12 hours at a temperature of 15° C. Following the water immersion, the barley was subjected to air ventilation for 14 hours at a temperature of 15° C. The second immersion was for 3 hours at 15° C. After steeping was completed, germination began and progressed for 5 days. The germinating barley was subjected to humidified air at a temperature of 15° C. The barley in each compartment was sprayed with water at the end of day 1, and at the end of days 2 and/or 3 depending upon the moisture content of the barley. Since the targeted moisture level of the barley at the end of germination was 45%, barley which was below this level at the end of each day was sprayed with water in increasing amounts depending on departure from this target. Table 2 below describes moisture content of the barley in each compartment at the end of day 1, 2, 3, and 4, as well as the amount of water sprayed onto the barley at the end of each of these days.

TABLE 2

| | Day 1 | | Day 2 | | Day 3 | | Day 4 | |
|---|---|---|---|---|---|---|---|---|
| Compartment | Moisture | Spray | Moisture | Spray | Moisture | Spray | Moisture | Spray |
| 1 | 43% | 50 mL | 45.8% | — | 45% | — | 45.5% | — |
| 2 | 42.8% | 50 mL | 43.5% | 50 mL | 44.4% | — | 45% | — |
| 3 | 40.7% | 100 mL | 42.2% | 100 mL | 43.5% | 100 mL | 46.3% | — |
| 4 | 40.3% | 100 mL | 41.8% | 100 mL | 42.3% | 100 mL | 44.6% | — |
| 5 | 35.8% | 200 mL | 36.2% | 200 mL | 36.5% | 100 mL | 38.1% | — |
| 6 | 35.9% | 200 mL | 35.4% | 200 mL | 36% | 100 mL | 37% | — |

The moisture level of the barley was not observed at the end of day 5, nor was the barley in any of the compartments sprayed during day 4 or day 5. After 5 days of germination, the barley in each compartment was kilned. During the wither phase of kilning, the green malt was heated for 12 hours at 63° C. In the pre-cure/post wither phase, the temperature was gradually increased from 63° C. to 85° C. over 8 hours. During the cure phase, the barley was heated to 85° C. for 3 hours.

Malt yield was measured in hectoliter weight for each sample from each of the 6 compartments. Table 3 shows the hectoliter weights for each sample.

TABLE 3

| Sample | Malt Yield in Hectoliter Weight (kg/100 L) |
|---|---|
| 1 (Control) | 53.1 |
| 2 | 54.1 |
| 3 | 54.8 |
| 4 | 58.1 |
| 5 | 63.5 |
| 6 | 62.9 |

As seen in Table 3, malt yield was improved through the addition of sodium chloride to the steeping and germination steps. For experimental samples 3, 4, 5, and 6, however, the barley kernels did not exhibit sufficient modification and therefore may not be useful as a commercial malted barley composition for brewing.

### Example 2

As in Example 1, a Joe White micromalting system was used to analyze samples of barley. One kilogram of barley was added to each of 4 compartments in the micro-malting unit. Table 4 describes experimental conditions utilized in this example.

TABLE 4

| Compartment/ | |
|---|---|
| Sample | Experimental Conditions |
| 1 (Control) | No NaCl used |
| 2 | 1% NaCl solution applied to germination at |
| | day 1 and day 2 |
| 3 | 2% NaCl solution applied to germination at |
| | day 1 and day 2 |
| 4 | 4% NaCl solution applied to germination at |
| | day 1 and day 2 |

A three immersions steep cycle was used. In the first immersion, the barley was immersed in water for 7 hours at 15° C. followed by ventilation for 8 hours at 15° C. In the second immersion, the barley was immersed in water for 5 hours at 15° C. followed by ventilation for 7 hours at 15° C. In the final immersion, the barley was immersed for 3 hours at 15° C. Following steeping, the barley was germinated for 5 days at 15° C. with a target moisture level of 43%-44% at the end of germination. Table 5 below describes moisture content of the barley in each compartment at the end of day 1, 2, 3, 4, and 5, as well as the amount of water sprayed onto the barley at the end of each of these days.

TABLE 5

| | Day 1 | | Day 2 | | Day 3 | | Day 4 | | Day 5 | |
|---|---|---|---|---|---|---|---|---|---|---|
| Compartment | Moist | Spray | Moist | Spray | Moist | Spray | Moist | Spray | Moist | Spray |
| 1 | 40% | 50 mL | 42.2% | 50 mL | 46.2% | — | 47.2% | — | 46.4% | — |
| 2 | 40.1% | 50 mL | 42% | 50 mL | 44.3% | — | 44.8% | — | 45% | — |
| 3 | 40.3% | 50 mL | 42.4% | 50 mL | 44.2% | — | 45% | — | 44.6% | — |
| 4 | 40.1% | 50 mL | 42% | 50 mL | 44.3% | — | 44% | — | 44.9% | — |

After 5 days of germination, the barley in each compartment was kilned. During the wither phase of kilning, the green malt was heated for 15 hours at 55° C. In the pre-cure/post wither phase, the temperature was gradually increased from 55° C. to 85° C. over 8 hours. During the cure phase, the barley was heated to 85° C. for 3 hours.

Malt yield was measured in hectoliter weight and 1,000 kernel weight for each of the 4 samples. Additionally, the quantity of rootlets per the quantity of malt was also measured for each sample. Table 6 displays this yield data.

TABLE 6

| | Hectoliter weight | 1,000 kernel weight | Quantity Rootlet/ |
|---|---|---|---|
| Sample | (kg/100 L) | (g) | Quantity Malt |
| 1 (Control) | 51 | 40.7 | 3.68% |
| 2 | 52.2 | 41 | 3.08% |
| 3 | 54 | 40.9 | 2.90% |
| 4 | 55.3 | 42.1 | 2.23% |

As seen in Table 6, malt yield improved in the experimental samples as compared to the control sample. In addition, the quantity of rootlets created was reduced in the experimental samples compared to the control. As in Example 1, however, the barley kernels from the experimental samples did not exhibit sufficient modification and therefore may not be useful as a commercial malted barley composition for brewing.

### Example 3

As in Examples 1 and 2, a Joe White micromalting system was again used to analyze samples of barley. One kilogram of barley was added to each of 4 compartments in the micro-malting unit. Table 7 describes experimental conditions utilized in this example.

TABLE 7

| Compartment/ | |
|---|---|
| Sample | Experimental Conditions |
| 1 (Control) | No NaCl used |
| 2 | 0.1% NaCl solution applied to germination at day 1 |
| 3 | 0.2% NaCl solution applied to germination at day 1 |
| 4 | 0.5% NaCl solution applied to germination at day 1 |

Steeping was conducted with the same parameters as described in Example 2. Following steeping, the barley was germinated for 5 days at 15° C. with a target moisture level of 42%-43% at the end of germination. Table 8 below describes moisture content of the barley in each compartment at the end of day 1, 2, 3, 4, and 5, as well as the amount of water sprayed onto the barley at the end of day 1. No other sprays were performed in this example.

TABLE 8

| | Day 1 | | Day 2 | | Day 3 | | Day 4 | | Day 5 | |
|---|---|---|---|---|---|---|---|---|---|---|
| Compartment | Moist | Spray | Moist | Spray | Moist | Spray | Moist | Spray | Moist | Spray |
| 1 | 43.2% | 50 mL | 47.2% | — | 47.2% | — | 46.8% | — | 47.1% | — |
| 2 | 42.4% | 50 mL | 45.5% | — | 45.7% | — | 45.4% | — | 44.7% | — |
| 3 | 43% | 50 mL | 45.7% | — | 46.6% | — | 46% | — | 45.8% | — |
| 4 | 42.2% | 50 mL | 45% | — | 45.1% | — | 45.1% | — | 44.6% | — |

After 5 days of germination, the barley in each compartment was kilned. During the wither phase of kilning, the green malt was heated for 15 hours at 55° C. In the pre-cure/post wither phase, the temperature was gradually increased from 55° C. to 85° C. over 8 hours. During the cure phase, the barley was heated to 85° C. for 3 hours.

Malt yield was measured in hectoliter weight for each of the 4 samples. Additionally, the quantity of rootlets per the quantity of malt was also measured for each sample. Table 9 displays this yield data.

TABLE 9

| | Hectoliter | Quantity Rootlet/ |
|---|---|---|
| Sample | weight (kg/100 L) | Quantity Malt |
| 1 (Control) | 50.8 | 5.41% |
| 2 | 52.5 | 4.29% |
| 3 | 52.6 | 4.69% |
| 4 | 52.9 | 4.27% |

As seen in Table 9, malt yield improved in the experimental samples as compared to the control sample. In addition, the quantity of rootlets created was reduced in the experimental samples compared to the control. Surprisingly, not only did malt yield improve and amount of rootlets decrease in the experimental samples, but the malt from the experimental sample exhibited similar modification to that of the control sample. The malt obtained from the experimental samples was well modified and of similar quality to the control sample. Thus, through the use of a food-safe salt, sodium chloride, in the germination stage of the malting process, malt yield was improved while also providing a well modified malt which would be useful in the commercial brewing of beer.

### Example 4

Five 2000 g samples of steeped barley were obtained from Cargill's Spiritwood, N. Dak. commercial malting facility. The samples were obtained from the same commercial steeped batch, after one day of commercial germination but before the first routine water spraying. Each sample completed a 4 day germination process and kilning in an in-house designed micro-malting system. The in-house designed micro-malting system emulated a conventional large scale malting system for processing conditions. Germination continued in the in-house designed micro-malting system with applied temperatures of 16.7° C. on day 2, 15.8° C. on day 3, and 17° C. on day 4 of germination. After 4 days of germination, each sample of germinated barley (green malt) was kilned. During the wither phase of kilning, the green malt was heated for 16 hours at 60° C. In the pre-cure/post wither phase, the temperature was increased to 74° C. for 2.5 hours, followed by another increase to 79° C. for 2.5 hours. During the cure phase, the barley was heated to 85° C. for 3.5 hrs. An additional final phase included a cool-down step of applying 27° C. for 1 hour.

Each sample was treated with a water solution at the 24 and 32 hour points in germination stage. In the experimental samples, the water solution contained a small dose of sodium chloride. Table 10 below describes experimental conditions utilized in this example.

TABLE 10

| Sample | Experimental Conditions |
|---|---|
| 1 (Control) | No NaCl used |
| 2 | 0.025% NaCl solution applied at 24 and 32 hours points in |
| | germination |
| 3 | 0.05% NaCl solution applied at 24 and 32 hours points in |
| | germination |
| 4 | 0.075% NaCl solution applied at 24 and 32 hours points in |
| | germination |
| 5 | 0.1% NaCl solution applied at 24 and 32 hours points in |
| | germination |

Malt yield was measured for the resulting malt in dry matter 1,000 kernel weight for each of the 5 samples. Table 11 displays this yield data.

TABLE 11

| Sample | Dry matter 1,000 kernel weight (g) |
|---|---|
| 1 (Control) | 28.35 |
| 2 | 28.26 |
| 3 | 28.27 |
| 4 | 28.66 |
| 5 | 29.4 |

As seen in Table 11, malt yield was improved for samples 4 and 5. In particular, sample 5, where 0.1% NaCl solution was applied at the 24 and 32 hours points in germination, surprisingly improved yield significantly compared to the control. Indeed, malt yield was improved more than 1% compared to the control. Such an improved yield would result in significant commercial benefit when malting barley or another cereal grain on a large scale.

### Example 5

Five 2000 g samples of steeped barley were obtained from Cargill's Spiritwood, N. Dak. commercial malting facility. The samples were obtained from the same commercial steeped batch, immediately after the batch's transfer from steeping to germination, and prior to the first routine water spraying. Thus, unlike Example 4, the samples did not undergo one day of commercial germination. Instead, each sample underwent a 4 day germination process and kilning in an in-house designed micro-malting system. Germination proceeded in the in-house designed micro-malting system with applied temperatures of 18.4° C. on day 1, 17.8° C. on day 2, 19.5° C. on day 3, and 18.8° C. on day 4 of germination. After 4 days of germination, each sample of germinated barley (green malt) was kilned. During the wither phase of kilning, the green malt was heated for 16 hours at 60° C. In the pre-cure/post wither phase, the temperature was increased to 74° C. for 2.5 hours, followed by another increase to 79° C. for 2.5 hours. During the cure phase, the barley was heated to 85° C. for 3.5 hrs. An additional final phase included a cool-down step of applying 27° C. for 1 hour.

Each sample was treated with a water solution at the 24 hour point in the germination stage. Two of the samples were control samples. Table 12 below describes the experimental conditions utilized in this example.

TABLE 12

| Sample | Experimental Conditions |
|---|---|
| 1 (Control 1) | Water (without NaCl) applied at 24 hour point in |
| | germination |
| 2 (Control 2) | Water (without NaCl) applied at 24 hour point in |
| | germination |
| 3 | 0.08% NaCl solution applied at 24 hour point in |
| | germination |
| 4 | 0.1% NaCl solution applied at 24 hour point in germination |
| 5 | 0.12% NaCl solution applied at 24 hour point in |
| | germination |

Malt yield was measured for the resulting malt in 1,000 kernel weight for each of the five samples. Table 13 displays this yield data.

TABLE 13

| Sample | 1,000 kernel weight (g) |
|---|---|
| 1 (Control 1) | 28.86 |
| 2 (Control 2) | 29.77 |
| 3 | 30.00 |
| 4 | 30.43 |
| 5 | 29.73 |

Table 13 shows that samples 3 and 4 show a yield improvement compared to the control samples. Sample 4, where 0.1% NaCl solution is applied at 24 hour point in germination provides significantly improved yield compared to the control samples.

### Example 6

Five 2000 g samples of steeped barley were obtained from Cargill's Spiritwood, N. Dak. commercial malting facility. As in example 5, the samples were obtained from the same commercial steeped batch, just after transfer to germination, and prior to the first routine water spraying. Each sample completed a 4 day germination process and kilning in an in-house designed micro-malting system. Germination continued in the in-house designed micro-malting system with applied temperatures of 16.3° C. on day 1, 17.6° C. on day 2, 16.9° C. on day 3, and 18.1° C. on day 4 of germination. After 4 days of germination, each sample of germinated barley (green malt) was kilned. During the wither phase of kilning, the green malt was heated for 16 hours at 60° C. In the pre-cure/post wither phase, the temperature was increased to 74° C. for 2.5 hours, followed by another increase to 79° C. for 2.5 hours. During the cure phase, the barley was heated to 85° C. for 3.5 hrs. An additional final phase included a cool-down step of applying 27° C. for 1 hour.

Each sample was treated with a water solution at the 24 hour point in the germination stage. Two of the samples were control samples. Table 14 below describes the experimental conditions utilized in this example.

TABLE 14

| Sample | Experimental Conditions |
|---|---|
| 1 (Control 1) | Water (without NaCl) applied at 24 hour point in |
| | germination |
| 2 (Control 2) | Water (without NaCl) applied at 24 hour point in |
| | germination |
| 3 | 0.1% NaCl solution applied at 24 hour point in germination |
| 4 | 0.15% NaCl solution applied at 24 hour point in |
| | germination |
| 5 | 0.2% NaCl solution applied at 24 hour point in germination |

Malt yield was measured for the resulting malt in 1,000 kernel weight for each of the five samples. Table 15 displays this yield data.

TABLE 15

| Sample | 1,000 kernel weight (g) |
|---|---|
| 1 (Control 1) | 30.77 |
| 2 (Control 2) | 30.63 |
| 3 | 31.51 |
| 4 | 31.04 |
| 5 | 30.21 |

Table 15 shows that samples 3 and 4 show a yield improvement compared to the control samples. Sample 3, again where 0.1% NaCl solution is applied at 24 hour point in germination provides significantly improved yield compared to the control samples.

### Example 7

Five 2000 g samples of steeped barley were obtained from Cargill's Spiritwood, N. Dak. commercial malting facility. As in examples 5 and 6 the samples were obtained from the same commercial steeped batch, just after transfer to germination, and prior to the first routine water spraying. Each sample completed a 4 day germination process and kilning in an in-house designed micro-malting system. Germination continued in the in-house designed micro-malting system with applied temperatures of 19.4° C. on day 1, 17.1° C. on day 2, 19.5° C. on day 3, and 19.7° C. on day 4 of germination. After 4 days of germination, each sample of germinated barley (green malt) was kilned. During the wither phase of kilning, the green malt was heated for 16 hours at 60° C. In the pre-cure/post wither phase, the temperature was increased to 74° C. for 2.5 hours, followed by another increase to 79° C. for 2.5 hours. During the cure phase, the barley was heated to 85° C. for 3.5 hrs. An additional final phase included a cool-down step of applying 27° C. for 1 hour.

Each sample was treated with a water solution at the 32 hour point in the germination stage. Two of the samples were control samples. Table 16 below describes the experimental conditions utilized in this example.

TABLE 16

| Sample | Experimental Conditions |
|---|---|
| 1 (Control 1) | Water (without NaCl) applied at 32 hour point in |
| | germination |
| 2 (Control 2) | Water (without NaCl) applied at 32 hour point in |
| | germination |
| 3 | 0.08% NaCl solution applied at 32 hour point in |
| | germination |
| 4 | 0.1% NaCl solution applied at 32 hour point in germination |
| 5 | 0.12% NaCl solution applied at 32 hour point in |
| | germination |

Malt yield was measured for the resulting malt in 1,000 kernel weight for each of the five samples. Table 17 displays this yield data.

TABLE 17

| Sample | 1,000 kernel weight (g) |
|---|---|
| 1 (Control 1) | 30.03 |
| 2 (Control 2) | 30.58 |
| 3 | 30.70 |
| 4 | 29.99 |
| 5 | 29.53 |

### Example 8

Five 2000 g samples of steeped barley were obtained from Cargill's Spiritwood, N. Dak. commercial malting facility. As in examples 5, 6, and 7, the samples were obtained from the same commercial steeped batch, just after transfer to germination, and prior to the first routine water spraying. Each sample completed a 4 day germination process and kilning in an in-house designed micro-malting system. Germination continued in the in-house designed micro-malting system with applied temperatures of 19.4° C. on day 1, 17.1° C. on day 2, 19.5° C. on day 3, and 19.7° C. on day 4 of germination. After 4 days of germination, each sample of germinated barley (green malt) was kilned. During the wither phase of kilning, the green malt was heated for 16 hours at 60° C. In the pre-cure/post wither phase, the temperature was increased to 74° C. for 2.5 hours, followed by another increase to 79° C. for 2.5 hours. During the cure phase, the barley was heated to 85° C. for 3.5 hrs. An additional final phase included a cool-down step of applying 27° C. for 1 hour.

Each sample was treated with a water solution at the 32 hour point in the germination stage. Two of the samples were control samples. Table 18 below describes the experimental conditions utilized in this example.

TABLE 18

| Sample | Experimental Conditions |
|---|---|
| 1 (Control 1) | Water (without NaCl) applied at 32 hour point in |
| | germination |
| 2 (Control 2) | Water (without NaCl) applied at 32 hour point in |
| | germination |
| 3 | 0.1% NaCl solution applied at 32 hour point in germination |
| 4 | 0.15% NaCl solution applied at 32 hour point in |
| | germination |
| 5 | 0.2% NaCl solution applied at 32 hour point in germination |

Malt yield was measured for the resulting malt in 1,000 kernel weight for each of the five samples. Table 19 displays this yield data.

TABLE 19

| Sample | 1,000 kernel weight (g) |
|---|---|
| 1 (Control 1) | 29.76 |
| 2 (Control 2) | 30.46 |
| 3 | 30.04 |
| 4 | 30.23 |
| 5 | 30.43 |

### Example 9

A 1 metric ton in-house malting system was used to test 2 samples of barley. The same malting system was used to malt each sample of barley. The system was first used to malt the experimental sample, then the control sample. The steeping for both samples was carried out at 15° C. and in the following manner: A first immersion of 9 hours, followed by 18 hours under ventilation, followed by a second immersion of 3 hours. After steeping, a 5 day germination process was utilized at 15° C. for all 5 days. Two sprayings were performed during germination for each sample. The first spraying was performed at 12 hours, and the second at 24 hours. For the control sample, untreated process water was used for both sprayings. For the experimental sample, untreated process water was used for the first spraying, and water treated with 0.1% NaCl was used for the second spraying. After the 5 day germination, the germinated barley (green malt) was kilned. During the wither phase of kilning, the green malt was heated for 12 hours at 55° C. In the pre-cure post wither phase, the temperature was slowly increased from 55° C. to 85° C. over 8 hours. During the cure phase, the barley was heated to 85° C. for 3 hours.

Table 20 describes experimental conditions utilized in this example.

TABLE 20

| Control Sample | NaCl not applied |
|---|---|
| Experimental Sample | 0.1% NaCl solution applied for the second spray |
| | in germination (at the 24 hour point) |

Malt yield was measured in dry matter yield. Dry matter yield is the ratio between finished clean malt and cleaned barley at steep-in on a dry matter basis. Yield was also measured by 1,000 kernel weight for each sample. In addition, the quantity of rootlets per the quantity of malt was also measured for each sample. Table 21 displays this yield data.

TABLE 21

| | Dry | 1,000 kernel | Quantity Rootlet/ |
|---|---|---|---|
| Sample | matter yield | weight (g) | Quantity Malt |
| Control Sample | 96.8 | 39 | 3.19% |
| Experimental Sample | 97.3 | 38.5 | 3.01% |

The dry matter yield data indicates an improvement in malt yield for the experimental sample. The quantity of rootlets created was also reduced in the experimental samples compared to the control. It was additionally discovered that the malt form the experimental sample was more modified than the malt from the control sample. For typical malt, a higher degree of modification can be correlated with higher yield losses (and therefore lower yield). Surprisingly, the dry matter yield data indicates that the experimental sample malt provided improved yield compared to the control despite a higher degree of modification.

In addition, for typical malt, more modification also generally correlates with more rootlet growth, more acrospire growth, and greater respiration losses. The experimental sample malt, however, developed less rootlet growth and less dry matter yield loss than the control.

### Example 10

A batch of 2009 crop Metcalfe variety of known malting performance was obtained from malting barley inventory in Cargill's Spiritwood, N. Dak. malt plant. A second batch of 2010 crop Metcalfe variety malting barley was similarly obtained. Each batch was split into several 1200 gm samples for micromalting. Samples were processed using an in-house designed micro-malting system.

Steeping for all samples was performed using a 2-immersion cycle. The barley was steeped with a first water immersion for 9 hours at a temperature of 13° C. followed by ventilation for 18 hours at a temperature of 18° C. The second immersion was for 7.5 hours at a temperature of 13° C. Following steeping, the samples were germinated for 4 days. Humidified air was applied throughout germination period. Germination proceeded with applied temperatures as follows: 2009 Metcalfe samples: 18° C. on day 1, 14.5° C. on day 2, 15.5° C. on day 3, and 17.7° C. on day 4; 2010 Metcalfe samples: 14° C. on day 1 through day 3, and 15.5° C. on day 4.

After 4 days of germination, each sample of germinated barley (green malt) was kilned. The green malt samples were kilned at the following temperatures: 2009 Metcalfe samples were heated for 18 hrs at 60° C., followed by heating for 12 hrs at 65.5° C., followed by heating for 6 hrs at 68.3° C., followed by heating for 4 hrs at 85° C.; 2010 Metcalfe samples were heated for 18 hrs at 62.7° C., followed by heating for 12 hrs at 65.5° C., followed by heating for 6 hrs at 68.3° C., followed by heating for 4 hrs at 85° C.

Three samples from each crop year were tested: one 2009 Metcalfe control sample, two 2009 Metcalfe experimental samples, as well as one 2010 Metcalfe control sample and two 2010 Metcalfe experimental samples Each control sample was watered with non-conditioned water. Of the 2 experimental samples per crop year, one was watered with potassium chloride conditioned water (0.13% KCl), the other with calcium chloride conditioned water (0.25% CaCl₂).

The germinating barley received a first watering at 24 hrs into germination. During this watering, the experimental samples were watered with KCl or CaCl₂ conditioned water. The control sample was watered with non-conditioned water. Both the control and experimental samples received the second watering using non-conditioned water only at approximately 32 hrs into germination process.

Table 22 describes experimental conditions utilized in this example.

TABLE 22

| Sample: | Water Treatment: |
|---|---|
| 2009 Metcalfe Control | Non-conditioned water only (at 24 hours 1st |
| | watering and at 32 hours 2nd watering) |
| 2009 Metcalfe | 0.25% CaCl₂ conditioned water (at 24 hrs 1st |
| Experimental Sample 1 | |
| (CaCl₂) | watering) |
| | Non-conditioned water (at 32 hrs 2nd watering) |
| 2009 Metcalfe | 0.13% KCl conditioned water (at 24 hrs 1st |
| Experimental Sample 2 | watering) |
| (KCl) | Non-conditioned water (at 32 hrs 2nd watering) |
| 2010 Metcalfe Control | Non-conditioned water only (at 24 hours 1st |
| | watering and at 32 hours 2nd watering) |
| 2010 Metcalfe | 0.25% CaCl₂ conditioned water (at 24 hrs 1st |
| Experimental Sample 2 | watering) |
| (CaCl₂) | Non-conditioned water (at 32 hrs 2nd watering) |
| 2010 Metcalfe | 0.13% KCl conditioned water (at 24 hrs 1st |
| Experimental Sample 2 | watering) |
| (KCl) | Non-conditioned water (at 32 hrs 2nd watering) |

Yield was measured by 1000 kernel count dry-matter basis. Samples were counted in triplicate, reporting the average. Table 23 describes this yield data.

TABLE 23

| | Avg. 1000 Kernel |
|---|---|
| Sample: | Wt (g) dry-matter |
| 2009 Metcalfe Control | 33.54 |
| 2009 Metcalfe Experimental Sample 1 (CaCl₂) | 34.90 |
| 2009 Metcalfe Experimental Sample 2 (KCl) | 35.59 |
| 2010 Metcalfe Control | 36.18 |
| 2010 Metcalfe Experimental Sample 2 (CaCl₂) | 36.74 |
| 2010 Metcalfe Experimental Sample 2 (KCl) | 36.66 |

As seen in table 23, yield values indicate the use of chloride salts at concentrations of 0.13% and 0.25% increased malt yield.

We claim:

1. A method for improving yield in the malting process comprising:
applying conditioned water to germinating cereal grain in the germination stage of the malting process,
wherein the conditioned water comprises from 0.025% to 2% chloride salt.

2. The method of claim 1, wherein the cereal grain is barley.

3. The method of claim 1, wherein the chloride salt is selected from the group consisting of sodium chloride, potassium chloride, calcium chloride, and mixtures of 2 or more thereof.

4. The method of claim 1, wherein the chloride salt is sodium chloride.

5. The method of claim 1, wherein the conditioned water is sprayed onto the cereal grain.

6. The method of claim 1, wherein the conditioned water comprises 0.1% to 1% chloride salt.

7. The method of claim 4, wherein the conditioned water comprises 0.1% to 0.5% sodium chloride.

8. The method of claim 1, wherein the conditioned water comprises 0.025% to 0.12% chloride salt.

9. The method of claim 4, wherein the conditioned water comprises 0.04%-0.08% sodium chloride.

10. The method of claim 1, wherein the conditioned water comprises 0.05%-0.2% chloride salt.

11. The method of claim 4, wherein the conditioned water comprises 0.08%-0.12% sodium chloride.

12. The method of claim 1, wherein the conditioned water is applied to the cereal grain within 48 hours from the start of germination.

13. The method of claim 1, wherein the conditioned water is sprayed onto the cereal grain within 32 hours from the start of germination.

14. The method of claim 1, wherein the cereal grain is barley and the conditioned water is sprayed onto the barley between 15 hours and 40 hours from the start of germination.

15. The method of claim 1, wherein the cereal grain is barley and the conditioned water is sprayed onto the barley between 30 hours and 48 hours from the start of germination.

16. The use of conditioned water in the germination stage of the malting process to improve malt yield, wherein the conditioned water comprises from 0.025% to 2% chloride salt, and the conditioned water is applied to cereal grains during the germination stage.

17. The use according to claim 16, wherein the chloride salt is sodium chloride.

18. The use according to claim 17, wherein the conditioned water comprises from 0.05% to 0.2% sodium chloride, the cereal grain is barley, and the conditioned water is sprayed onto the barley within 48 hours from the start of germination.

19. The use according to claim 17, wherein the conditioned water comprises from 0.025% to 0.12% sodium chloride, the cereal grain is barley, and the conditioned water is sprayed onto the barley within 32 hours from the start of germination.

20. The use according to claim 17, wherein the conditioned water comprises from 0.1% to 1% sodium chloride, the cereal grain is barley, and the conditioned water is sprayed onto the barley between 15 hours and 40 hours from the start of germination.
